(19) United States
(12) Patent Application Publication
(10) Pub. No.: US 2001/0047980 A1
(43) Pub. Date: Dec. 6, 2001

(54) Process for converting a metal carbide to diamond by etching in halogens

(76) Inventors: Michael J. McNallan, Oak Park, IL (US); Daniel Ersoy, Lincolnwood, IL (US); Yury Gogotsi, Ivyland, PA (US); Sascha Welz, Chicago, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/838,458

(22) Filed: Apr. 19, 2001

Related U.S. Application Data
(63) Continuation-in-part of application No. 09/568,312, filed on May 9, 2000.
(60) Provisional application No. 60/152,013, filed on Sep. 1, 1999.

(51) Int. Cl. C23F 1/00; B44C 1/22

(52) U.S. Cl. 216/75; 216/81

(57) ABSTRACT

A process for the synthesis of carbon coatings on the surface of metal carbides, preferably SiC, by etching in a halogen-containing gaseous etchant, and optionally hydrogen gas, leading to the formation of a carbon layer on the metal carbide. The reaction is performed in gas mixtures containing 0 to two moles of hydrogen for every two moles of halogen gas, preferably about 0.5 to one mole of hydrogen gas for eery two moles of halogen gas, at temperatures from about 100° C. to about 4,000° C., preferably about 800° C. to about 1,000° C., over any time range, maintaining a pressure of preferably about one atmosphere.

### CROSS-REFERENCE TO RELATED APPLICATION

This application is a continuation-in-part of co-pending application Ser. No. 09/568,312, filed May 9, 2000, which claims priority from provisional application Serial No. 60/152,013 filed Sep. 1, 1999.

This invention was made with government support under Grant CMS-9813400 awarded from the NSF Tribology and Surface Engineering Program.

### FIELD OF THE INVENTION

This invention relates to a process for converting a metal carbide to diamond on a surface of a metal carbide, or a material that has predominantly a diamond surface, e.g., coating, by etching in a halogen-containing and hydrogen-containing gas.

### BACKGROUND OF THE INVENTION AND PRIOR ART

The extraction of silicon from silicon carbide powders and fibers by halogens (F₂, Cl₂, Br₂, I₂ or mixtures) or compounds containing one or more halogens (e.g., HF, CCl₄, and the like) can lead to the formation of free carbon—see Gogotsi, et al. “Carbon coatings on silicon carbide by reaction with chlorine-containing gases”, J. Mater. Chem., pp. 1841-1848 (1997); and Gogotsi, et al. “Formation Of Carbon Coatings On SiC Fibers By Selective Etching In Halogens And Supercritical Water”, 22nd Annual Conference on Composites, Advanced Ceramics, Materials, and Structures: A, Ceramic Engineering and Science Proceedings, Vol. 19, December 1998. This method can be used to obtain carbon from SiC, TiC, WC and other carbides that form volatile halides (SiCl₄ and TiCl₄ are typical examples), but do not form soluble oxides. This process can be considered as a reaction of the following type:

MC(s)+D(g)=C(s)+M_{y}Dₓ(g)+D_{z}(g)

where MC is a metal carbide, D is a gaseous halogen or halogen-containing etchant (e.g., Cl₂, HCl, and the like), M_{y}Dₓ is a gaseous fragment reaction product species, and D_{z} is another possible fragment reaction product species. This type of reaction can lead to the formation of free carbon, that may maintain the sp³ structure which it has in carbide and form diamond. Alternatively, it can be transformed to graphite, or form various amorphous or disordered carbon structures intermediate to diamond and graphite.

Specifically, for the preferred metal carbide, silicon carbide, the chlorination reactions:

SiC(s)+2Cl₂(g)=SiCl₄(g)+C(s) and

SiC(s)+4HCl(g)=SiCl₄(g)+C(s)+2H₂(g)

lead to the formation of a carbon surface, or a carbon coating, on the surface of metal carbides or to the complete transformation of carbide particles into carbon. This is due to the fact that a metal-halogen, e.g., SiCl₄, is much more thermodynamically stable than a carbon-halogen, e.g., CCl₄, at elevated temperatures, so that chlorine reacts selectively with the Si at SiC surfaces leaving carbon behind. The structure of the carbon layer is affected by temperature and by the composition of the chlorinating gas mixture. In accordance with the present invention, carbon films or surface layers were formed as an integral part of monolithic metal carbide parts on the surface of commercially available monolithic α-SiC and β-SiC specimens by high temperature (100° C. or greater) chlorination at atmospheric pressure in H₂-Cl₂ and Cl₂ gas mixtures, using an inert gas, such as Argon, to dilute the halogen gas content to a desired concentration.

Commercial methods of synthesis of diamond coatings have serious limitations. The CVD method does not allow the synthesis of coatings on powders and other particulate materials. Heteroepitaxial growth of diamond by CVD still has its problems. Generally CVD and Physical Vapor Deposition (PVD) processes exhibit low rates of deposition and require a nucleation pre-treatment for diamond synthesis—see Yang, U.S. Pat. No. 5,298,286—March 1994. Plasma-assisted CVD is especially slow and energy-consuming technique—see Kieser, U.S. Pat. No. 4,661,409—April 1987, and U.S. Pat. No. 4,569,738—February 1986. Moreover, diamond films deposited with the CVD and PVD methods do not generally adhere to the substrate, often peeling off during loading which can take place in tribological applications of carbon coatings, such as in cutting tools, bearings, seals, and the like. Special techniques used to improve adhesion between diamond films and other ceramic substrates have not been completely successful, particularly on WC tools because of the large differences in physical properties between diamond and WC. Other methods that have been used to produce diamond films with special properties include laser vaporization—see Mistry, U.S. Pat. No. 5,731,046—March 1998; high temperature synthesis, sputtering—Pulker, U.S. Pat. No. 4,173,522—November 1979; pyrolisis—Beatty, U.S. Pat. No. 4,016,304—April 1977, Bokros, U.S. Pat. No. 3,977,896—August 1976, Araki, U.S. Pat. No. 3,949,106—April 1976; decomposition of organic materials and ion beam deposition—Dearnaley, U.S. Pat. Nos. 5,731,045; 5,725,573—March 1998, U.S. Pat. No. 5,512,330—April 1996, U.S. Pat. No. 5,393,572—February 1995, U.S. Pat. No. 5,391,407—February 1995, Cooper U.S. Pat. No. 5,482,602—January 1996, Bailey, U.S. Pat. No. 5,470,661—November 1995, and Malaczynski, U.S. Pat. No. 5,458,927—October 1995. Most of these processes are expensive and energy-intensive. Additionally, there is no single versatile method that could provide all types of carbon coatings.

Another process which could be used to synthesize carbon coatings on the surface of carbides is by hydrothermal leaching—see Gogotsi, Ukrainian Patent 10393A; and Yoshimura, Japanese Patent 07,232,978. Both graphitic carbon and diamond can be obtained by interaction of SiC with water. However, the hydrothermal method can only be applied to carbides that form soluble or volatile hydroxides, such as Si(OH)₄. Additionally, the use of high-pressure autoclaves in hydrothermal synthesis can make scaling up of hydrothermal reactors difficult and expensive. Hydrothermal etching of SiC produced sp³-bonded carbon and some diamond, but the process was plagued by a low yield and poor reproducibility, because of the difficult control over the concentration/activities of chemical species in high-pressure autoclaves.

Commercially used high-pressure synthesis produces diamond powders and small crystals; chemical vapor deposition (CVD coatings) and shock wave synthesis (nanocrystalline powders) of diamond have serious limitations—particularly low production volumes and a high cost. Recently suggested methods of diamond growth also require plasma activation, high pressures, exotic precursors, or explosive mixtures, have a very low yield and are intrinsically limited to small volumes or thin films, thus failing to provide a way to a low-cost, large-volume synthesis of diamond.

As disclosed in the parent application, selective etching of carbides is an attractive technique for synthesis of carbon coatings. Supercritical water or halogens can be used to remove silicon from SiC, producing carbide-derived carbon (CDC) films and powders that may have a variety of structures depending on the experimental conditions.

### SUMMARY OF THE INVENTION

In brief, by treating a metal carbide, preferably a monolithic part that is predominantly a metal carbide or has predominantly a metal carbide surface, e.g., coating, with a gaseous mixture of a halogen and hydrogen containing 0 to two moles, preferably at least 0.3 mole of hydrogen for every two moles of halogen, more preferably at least 0.5 mole of hydrogen per two moles of halogen, most preferably at least 0.75 mole of hydrogen per two moles of halogen, relatively thick diamond coatings or surface layers are obtained.

The process of the present invention can be carried out at atmospheric pressure and does not require plasma or other high-energy sources.

Impure raw SiC can be used in accordance with the present invention containing predominantly (more than 50% by weight) SiC, preferably at least 80% SiC, because halogenation will remove most metallic impurities from the predominantly SiC material.

Unlike CVD, not only carbide components or fibers can be coated, but also powders, whiskers and platelets.

Monolithic parts with complex shapes and surface morphologies can be diamond “coated” in accordance with the present invention. It is the halogen reaction gas in contact with the carbide surface that transforms the material to diamond and minimum hydrogen content at atmospheric pressure that maintains the diamond surface with time without the diamond surface deteriorating to amorphous carbon. This is important for two reasons. First, the reaction can proceed anywhere the gas can reach, e.g., crevices, channels, intricate layered surfaces, holes, and the like. This would be impossible with most of the other current available processes. Second, it allows control of growth on the atomic level.

Templating of the surface structure/coating will allow various pore sizes (angstroms to nanometers).

The process of the present invention is environmentally friendly technology since it can be operational as a closed loop process with the recovery of Si by decomposition of the metal halide, e.g., SiCl₄, and returning the halogen gas to the manufacturing process.

In accordance with the present invention, relatively large volumes of nano- and microcrystalline diamond can be synthesized, at low cost, by the extraction of silicon from silicon carbide in chlorine-containing gases, and preferably at ambient pressure, and preferably at temperatures not exceeding 1,000° C. No plasma or other high-energy activation is required, thus providing an opportunity for large-scale production. The presence of at least 0.3 mole of hydrogen for each two moles of halogen in the gas mixture leads to a complete conversation of SiC to diamond, with the average crystallite size of 5-10 nm, and without deterioration of the diamond to graphitic carbon as the reaction proceeds with time. Thick and thin coatings, polycrystalline powders with any grain size or micro-components can be made in accordance with the method of the present invention. The linear diamond growth kinetics, accomplished in accordance with the method of the present invention, allows transformation of metal carbide to diamond to any depth, ultimately until the whole SiC particle or component is transformed to diamond. Nanocrystalline diamond coatings demonstrate hardness values in excess of 50 GPa and Young's modulus up to 800 GPa.

The molar ratio of hydrogen to halogen should be less than 1:1 to avoid complete conversion to HCl, which would reduce the activity of the halogen to a level at which it would be ineffective. The most preferred molar ratio of hydrogen to halogen is in the range of 0.5 to 1 mole of hydrogen for every two moles of halogen.

One object of the present invention is to provide a new method of producing diamond layers at low cost on metal carbides on the surface of commercially available SiC (and other metal carbides).

Another object of the present invention is to provide improved interfacial strength between the diamond layer and the substrate metal carbide compared to other methods.

A further object of the present invention is to provide a new method of diamond or diamond layer (coating) formulation.

A further object of the present invention is to provide a new method of non-cubic diamond synthesis (hexagonal diamond and nano-crystalline diamond structures).

Yet another object of the present invention is to provide a new method of diamond coating on metal carbides at atmospheric pressure vs. higher pressures or lower (vacuum) pressures (which are more dangerous, expensive, and slow).

Still yet another object of the present invention is to provide a new method of diamond coating on metal carbides that does not require plasma or other expensive high-energy sources.

Another object of the present invention is to allow the use of impure, raw SiC (or other metal carbide) to be used (hence save money) in the production of diamond coated metal carbides.

Another object of the present invention is to allow not only carbide components or fibers to be coated with diamond, but also powders, whiskers and platelets (not possible with current processes, CVD, PVD, and the like).

A further object of the present invention is to allow parts with complex shapes and surface morphologies to be diamond coated, e.g., crevices, channels, intricate layered surfaces, holes, etc.

Yet another object of the present invention is to allow control of diamond coating growth on the atomic level.

Still yet another object of the present invention is to allow variation in pore sizes (angstroms to nanometers) of diamond coatings to tailor surface properties.

Another object of the present invention is to provide a new environmentally friendly technology for diamond coating of metal carbides.

The above and other objects and advantages of the present invention will become more apparent from the following detailed description of the preferred embodiments, read in conjunction with the drawings.

### BRIEF DESCRIPTION OF THE DRAWINGS

Throughout this specification, and drawings, percentages and ratios of halogen and hydrogen are mole percents and molar ratios.

FIG. 1 is a graph showing the results of nanoindentation tests. (a), typical indentation load-displacement curves obtained on polished surfaces of sintered SiC (blue curve), as well as carbon coatings produced in Ar containing 3.5% Cl₂ (black curve) and in Ar containing 2.77% Cl₂; 1.04% H₂ (red curve). Inset shows a SEM micrograph of the hard coating produced by treatment in Ar containing 2.77% Cl₂; 1.04% H₂ for 30 hours at 1,000° C. H is hardness, E is Young's modulus measured on the polished surface using depth-sensing indentation. (b), hardness vs. Young's modulus for various carbon materials, silicon and SiC. Bars show standard deviations.

FIG. 2 is high-resolution TEM micrographs showing the structure of the carbon coating within a micrometer from the SiC/carbon interface. (a), diamond nanocrystals surrounded by graphitic carbon, including onion-like structures. (b), region of nanocrystalline diamond. The sample was treated for 24 hours at 1,000° C. in Ar containing 3.5% Cl₂.

FIG. 3 shows diamond microcrystals embedded in amorphous carbon. (a), TEM image. (b), SEM image. (c), EELS spectra. The [011] SAD pattern (inset in (a)) and the EELS spectra in (c) show that the rounded particles are diamonds. The light material in (a) was identified as carbon with a high content of sp³ bonding and some sp² bonding using EELS (c). Etching in hydrogen plasma removes selectively amorphous and disordered carbon revealing diamond crystals in the carbon layer (b). The rounded shape of the microcrystals can be explained by their solid-state growth via coalescence of nanocrystals when constrained by the carbon matrix.

FIG. 4 shows the microstructure of a diamond film produced in Cl₂/H₂. (a), SEM micrograph of a fracture surface showing a carbon layer over the SiC substrate. (b), typical TEM micrograph of the nanocrystalline diamond layer produced with hydrogen present in the reaction gas. Sample was sintered α-SiC treated in 2.77% Cl₂; 1.04% H₂ (balance Ar) for 30 hours at 1,000° C.

FIG. 5 shows convergent-beam electron diffraction patterns from nanocrystals (5-10 nm size) in a sample treated in Ar containing 3.5% chlorine at 1,000° C. The diamond-containing area was within a micrometer from the SiC/carbon interface. (a) and (b), may be attributed to cubic diamond with reflections 0.206 nm (111), and 0.126 nm (022), as well as forbidden diamond reflections. (c) and (d) may be attributed to hexagonal diamond lonsdaleite with reflections at 0.219 (100) and 0.126 nm (110). (e), EDS spectrum showing that the analyzed material is nearly pure carbon. Traces of amorphous silica were presented due to oxygen impurity in the gas. The copper peak comes from the supporting grid. Other EDS spectra from the analyzed areas showed even lower content of impurities in carbon.

FIG. 6 is a SAD pattern from the nanocrystalline film. Sharp Bragg reflections are visible up to the order of (800), indicating good crystallinity. No scattering intensity from either graphite or amorphous carbon can be seen, suggesting that the film is pure diamond, but high intensity of forbidden reflections suggests a lower symmetry or impurity superstructure. Sample was sintered α-SiC treated in 2.77% Cl₂; 1.04% H₂ (balance Ar) for five hours at 1,000° C.

FIG. 7 schematically illustrates a ball and socket prosthesis adapted for shoulder arthroplasty in accordance with the present invention;

FIG. 8 schematically illustrates a hinge joint prosthesis adapted for finger, elbow and knee arthroplasty in accordance with the present invention;

FIG. 9 schematically illustrates an ovoidal joint prosthesis adapted for wrist arthroplasty in accordance with the present invention;

FIG. 10 schematically illustrates a saddle joint prosthesis adapted for thumb joint arthroplasty in accordance with the present invention;

FIG. 11 schematically illustrates a pivot joint prosthesis adapted for forearm arthroplasty in accordance with the present invention;

FIG. 12 schematically illustrates a gliding joint prosthesis adapted for carpus arthroplasty in accordance with the present invention;

FIG. 13 schematically illustrates a complete knee joint prosthesis adapted in accordance with the present invention; and

FIG. 14 is an exploded view of an automotive water pump showing a seal treated in accordance with the present invention.

Other objects and advantages of the present invention will become apparent from the following detailed description of the preferred embodiments, taken in connection with the accompanying drawings, wherein, by way of illustration and example, an embodiment of the present invention is disclosed.

The present invention is directed to a process for the synthesis of diamond, and diamond coatings on the surface of metal carbides by etching a metal carbide with an etchant gas containing both a halogen and hydrogen comprising the steps of etching a metal carbide with a halogen-containing gaseous etchant containing hydrogen gas in an amount in the range of 0 moles to less than two moles of hydrogen, preferably 0.5 mole to one mole of hydrogen, for every two moles of halogen gas, leading to the formation of a gaseous fragment reaction product species and possibly other fragment species, leading to the formation of diamond or a diamond surface layer on the metal carbide. The reaction is performed in such hydrogen and halogen gas mixtures at temperatures from about 100° C. to about 4,000° C. over any time range, preferably maintaining a pressure of at least about 0.001 atmosphere, more preferably about one atmosphere, to about 100 atmospheres, and leading to the formation of said diamond layer on the surface of the metal carbide or to the complete transformation of the carbide material into diamond.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriate detailed system, structure or manner.

The preferred metal carbide is silicon carbide, SiC, preferably α-SiC, however the diamond conversion process of the present invention can be performed on any metal carbide. The following two articles, hereby incorporated by reference, written by McNallan, Gogotsi, and Jeon, describe Cl₂ etching of TiC and TaC starting materials: Proceedings of the NFS/ASME Workshop on Tribology Issues and Opportunities in MEMS, Klumer Academic Publishers, pages 559-565 (1998); and Preparation of Carbon Films by High Temperature Chlorination of Metal Carbides, High Temperature Materials Chemistry, Electrochemical Society Proceedings Volume 97-39, pages 529-536 (1997); both articles hereby incorporated by reference. Examples of suitable metal carbides are shown in Table 1, as follows:

TABLE 1
Carbide Compounds

| | | CAS Registry | |
|---|---|---|---|
| Carbide | | Number | Formula |
| aluminum carbide | (4:3) | [1299-86-1] | Al₄C₃ |
| arsenic carbide | (2:6) | | As₂C₆ |
| beryllium carbide | (2:1) | [57788-94-0] | Be₂C |
| boron carbide | (4:1) | [12069-32-8] | B₄C |
| calcium carbide | (2:1) | [75-20-7] | CaC₂ |
| chromium carbide | (1:1) | [12011-60-8] | CrC |
| chromium carbide | (3:2) | [12012-35-0] | Cr₃C₂ |
| chromium carbide | (4:1) | [12075-40-7] | Cr₄C |
| chromium carbide | (7:3) | [12075-40-0] | Cr₇C₃ |
| chromium carbide | (23:6) | [12105-81-6] | Cr₂₃C₆ |
| cobalt carbide | (3:1) | [12011-59-5] | Co₃C |
| cobalt tungsten carbide | (6:6:1) | [12538-07-7] | Co₆W₆C |
| hafnium carbide | (1:1) | [12069-85-1] | HfC |
| iron carbide | (1:1) | [12069-60-2] | FeC |
| iron carbide | (2:1) | [12011-66-4] | Fe₂C |
| iron carbide | (3:1) | [12011-67-5] | Fe₃C |
| iron carbide | (3:1) | [12169-32-3] | Fe₃C |
| iron carbide | (5:2) | [12127-45-6] | Fe₅C₂ |
| iron carbide | (7:3) | [12075-42-2] | Fe₇C₃ |
| iron carbide | (23:6) | [12012-72-5] | Fe₂₃C₆ |
| lanthanum carbide | (1:2) | [12071-15-7] | LaC₂ |
| manganese carbide | (3:1) | [12121-90-3] | Mn₃C |
| manganese carbide | (23:6) | [12266-65-8] | Mn₂₃C₆ |
| magnesium carbide | (1:2) | [12122-46-2] | MgC₂ |
| magnesium carbide | (2:3) | [12151-74-5] | Mg₂C₃ |
| molybdenum carbide | (1:1) | [12011-97-1] | MoC |
| molybdenum carbide | (2:1) | [12069-89-5] | Mo₂C |
| molybdenum carbide | (23:6) | [12152-15-7] | Mo₂₃C₆ |
| nickel carbide | (1:1) | [12167-08-7] | NiC |
| nickel carbide | (3:1) | [12012-02-1] | Ni₃C |
| niobium carbide | (1:1) | [12069-94-2] | NbC |
| niobium carbide | (2:1) | [12011-99-3] | Nb₂C |
| plutonium carbide | (1:1) | [12070-03-0] | PuC |
| plutonium carbide | (2:3) | [12076-56-1] | Pu₂C₃ |
| phosphorus carbide | (2:6) | | P₂C₆ |
| scandium carbide | (1:1) | [12012-14-5] | ScC |
| silicon carbide | (1:1) | [409-21-2] | SiC |
| tantalum carbide | (1:1) | [12070-06-3] | TaC |
| tantalum carbide | (2:1) | [12070-07-4] | Ta₂C |
| thorium carbide | (1:1) | [12012-16-6] | ThC |
| thorium carbide | (1:2) | [12071-31-7] | ThC₂ |
| titanium carbide | (1:1) | [12070-08-5] | TiC |
| tungsten carbide | (1:1) | [12070-12-1] | WC |
| tungsten carbide | (2:1) | [12070-13-2] | W₂C |
| uranium carbide | (1:1) | [12170-09-6] | UC |
| uranium carbide | (1:2) | [12071-33-9] | UC₂ |
| uranium carbide | (2:3) | [12076-62-9] | U₂C₃ |
| vanadium carbide | (1:1) | [12070-10-9] | VC |
| vanadium carbide | (2:1) | [12012-17-8] | V₂C |
| zirconium carbide | (1:1) | [12020-14-3] | ZrC |

The process of the present invention is inherently different from other coating processes in that the metal carbide substrate (carbide surface) is actually transformed into diamond from the surface down into the metal carbide substrate. This differs from “film” or coating applications which are applied or grown on top of the substrate. In accordance with the present invention, diamond layers are formed on the surface of metal carbides by etching in halogens and hydrogen with a particular ratio of halogen to hydrogen gas. This is accomplished by reacting the carbides with a reaction gas which contains from 0 to less than two moles of hydrogen gas for every two moles of halogen gas; preferably 0.5 to one mole of hydrogen for every two moles of halogen; most preferably 0.75 to one mole of hydrogen for every two moles of halogen, in a reaction vessel at a temperature between 100° C. to 4,000° C. at a pressure between 0 atmospheres and 100 atmospheres, preferably about one atmosphere. In the preferred embodiment, the temperature is between 800° C. and 1,000° C. and at atmospheric pressure (about one atmosphere) with the metal carbide being silicon carbide and the halogen etchant being chlorine gas, at a hydrogen gas to chlorine gas molar ratio of 0.75:2.

The advantages of this method are the adherence of the film or coating. The interface is where the coating “grows into” the metal carbide substrate, providing excellent resistance to fracture and wear. In addition, since the method of the present invention does not add a coating material on top of the metal carbide, but rather transforms the metal carbide into diamond, one can achieve a complete transformation of the metal carbide substrate into diamond.

Extraction of metals from carbides by chlorine leads to the formation of free carbon with various structures and pure diamond can be produced, or diamond films can be produced on SiC surfaces, by high temperature chlorination in the presence of hydrogen. Since SiCl₄ is much more thermodynamically stable than CCl₄ at elevated temperatures, chlorine reacts selectively with the silicon at SiC surfaces, leaving diamond behind, over the SiC substrate, at particular halogen/hydrogen ratios.

Because the reaction is controlled and initiated by the contact of a gaseous phase with the surface of the metal carbide structure, it allows monolithic parts with complex shapes, crevices, channels, intricate layered surfaces, holes, and other intricate surface morphologies to be treated. The process of the present invention is extremely advantageous compared to existing coating processes which generally require a “line-of-sight” to lay down the coating. In this way, not only carbide components or fibers can be diamond coated, but also powders, whiskers, nanotubes, and platelets (not possible with current processes, CVD, PVD and the like), can be produced as diamond, or diamond coated.

Moreover, the tailoring of the process by change of reaction gas composition, temperature, and time allows the production of diamond layers with varying structure, porosity, density, and other properties. Similarly, the process allows the control of diamond layer growth on the atomic level. It is to be noted that since the metal carbide itself is transformed into diamond, the original size and dimensions of a monolithic SiC part are retained, allowing the part to be treated without loss of dimensional integrity, hence saving machining costs.

It is evident that this process allows the use of the same reactor vessel, of almost any volume, for all types of diamond coatings desired. Since the process in its preferred embodiment takes place at atmospheric pressure, it is safer and cheaper than those processes (like hydrothermal etching) which take place at elevated pressures as well as those processes that take place under vacuum. Attention is also drawn to the fact that this process does not require plasma or other expensive high-energy sources. Means is provided for an environmentally friendly technology since the process can be performed close-circuit with all products reclaimed.

Thus, the advantages of this invention include the production of diamond layers on a metal carbide for the purpose of achieving an adherent diamond layer with tailored structure and mechanical properties in an inexpensive, simple, environmentally friendly manner. Not only can the dimensional accuracy of a monolithic part be retained, but complex shapes of any size (nano to macro) can be treated in a way not possible by any existing method.

It was possible to control the above coating thickness, porosity, and morphologies by varying the Cl₂ to H₂ ratio, reaction temperature and time. Diamond surface layers from only a few microns to hundreds of microns thick were obtained. In fact, there is no limit to the thickness of the diamond coatings since an entire monolithic piece of metal carbide material can be transformed to a diamond with sufficient time of reaction.

Experimental

The synthesis of diamond was conducted at ambient pressure in a quartz tube furnace at or below 1,000° C. The SiC samples were exposed to flowing gas mixtures of 1-3.5% Cl₂, 0-2% H₂, with the balance Ar as a carrier gas. Since SiCl₄ is much more thermodynamically stable than CCl₄, chlorine reacts selectively with the silicon at SiC surfaces by the reaction

SiC+2Cl₂=SiCl₄+C (1)

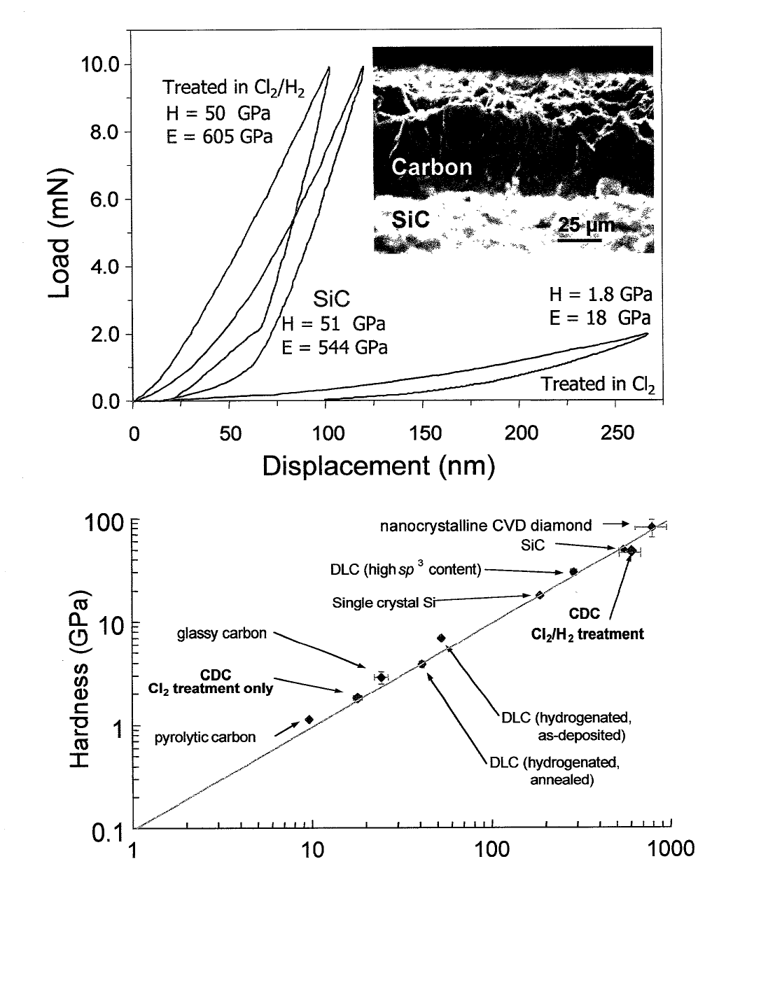

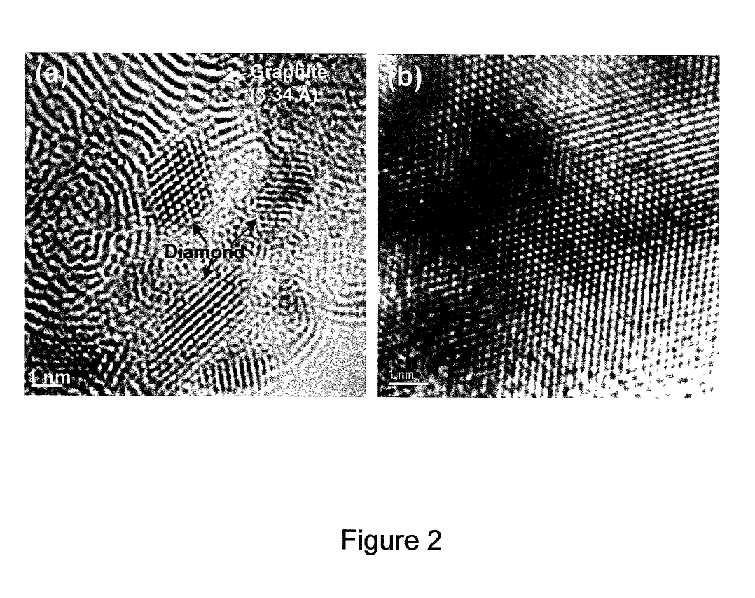

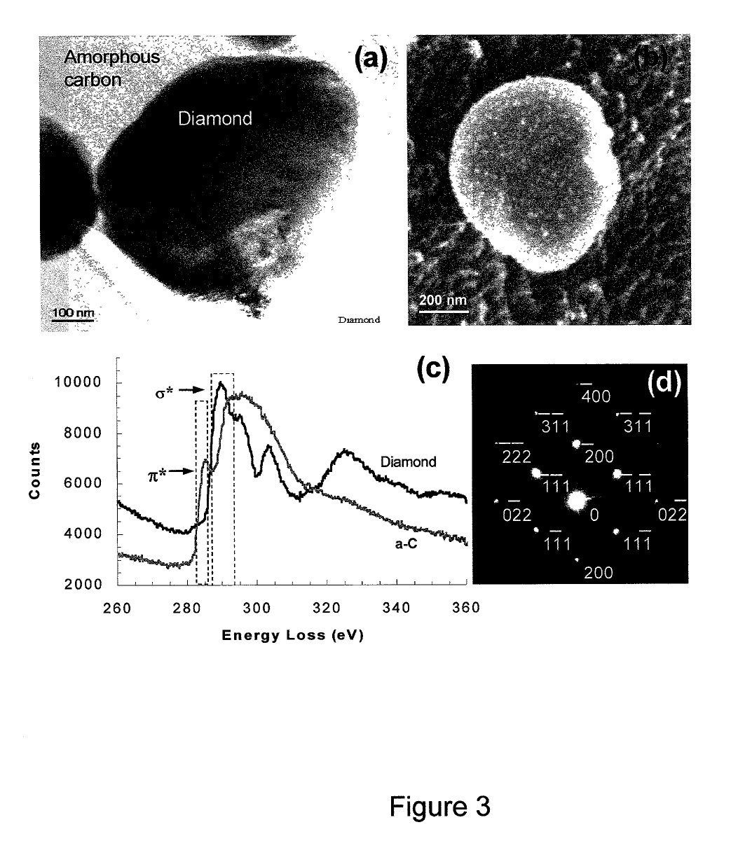

leaving diamond behind, over the SiC substrate. CDC coatings produced by treatment of sintered SiC in Ar-3.5% Cl₂ had black color and were graphitic, according to X-ray diffraction (XRD) and Raman spectroscopy. They showed a low hardness and Young's modulus (FIG. 1). However, cross-sectional hardness measurements using the nanoindenter demonstrated existence of an intermediate layer of several micrometers in thickness between SiC and graphitic carbon. The material in this layer had average hardness of about 20-30 GPa and Young's modulus of 200-300 GPa. Transmission electron microscopy (TEM) studies of this layer (FIG. 2) have shown that it consists of a mixture of graphitic carbon (onions, ribbons and disordered carbon) and nanocrystalline diamond (FIG. 2a). In some regions, large areas of nanocrystalline diamond (FIG. 2b) or diamond microcrystals (FIG. 3) were embedded in amorphous carbon. Lattice fringing, selected area electron diffraction (SAD), convergent-beam electron diffraction (CBED) and electron energy loss spectroscopy (EELS) confirm the formation of diamond in this layer. However, lattice fringes and diffraction spots at ˜0.193 nm and ˜0.218 nm (Table 2), as well as characteristic CBED images suggest formation of 2H hexagonal diamond (lonsdaleite) along with cubic diamond. Lonsdaleite has been often observed in nanocrystalline diamond films and accompanied SiC in some natural samples.

TABLE 2
Experimental d spacings in comparison with d spacings
and indexes of diamond and lonsdaleite

| | Cubic Diamond | | Lonsdaleite | |
|---|---|---|---|---|
| Experimental* | Fd3m (JSPDS 6-0675) | | P63/mmc (JSPDS 19-268) | |
| d spacing* | | d spacing | | d spacing |
| (nm) | hkl | (nm) | hkl | (nm) |
| 0.218-0.222 | | | 100 | 0.218 |
| 0.206-0.207 | 111 | 0.206 | 002 | 0.206 |
| 0.192-0.194 | | | 101 | 0.193 |
| 0.178-0.182 | 200** | 0.178 | | |
| 0.150 | | | 102 | 0.150 |
| 0.126 | 220 | 0.126 | 110 | 0.126 |
| 0.117 | | | 103 | 0.116 |
| 0.110 | | | 020 | 0.1092 |
| 0.106 | 311 | 0.1075 | 112 | 0.1075 |

*Typical values from SAD, CBED and lattice fringe measurements on about 30 diamond single crystals (5-500 nm in size) from three different samples.
**Forbidden cubic diamond reflection.

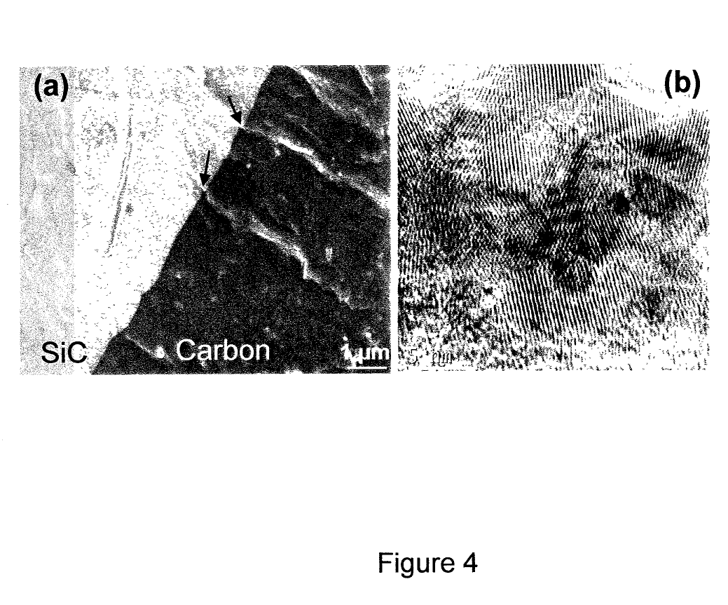

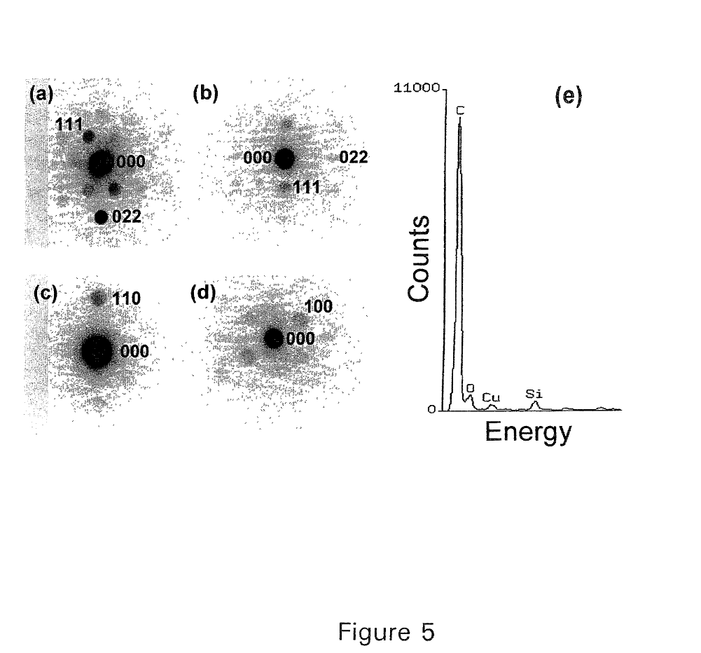

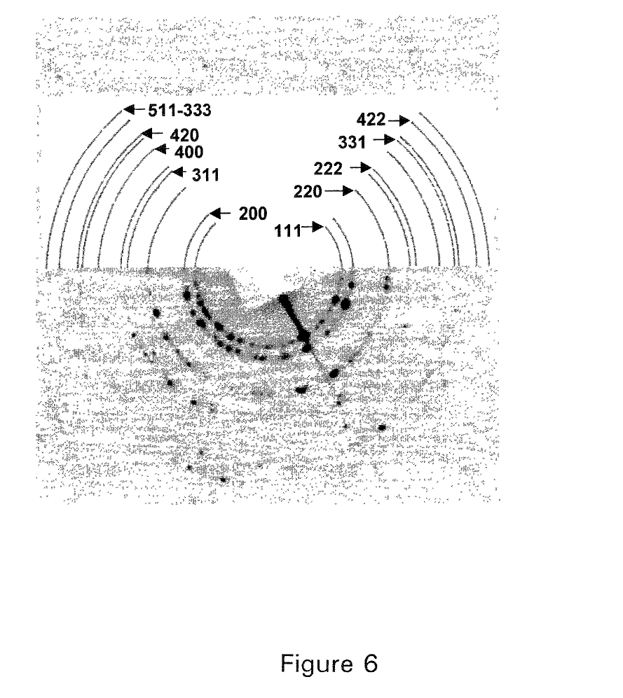

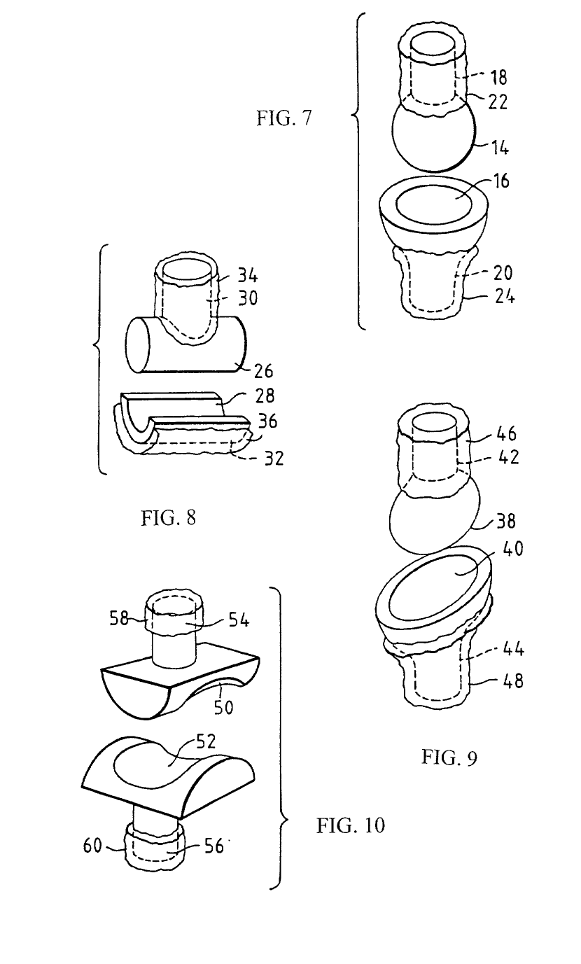

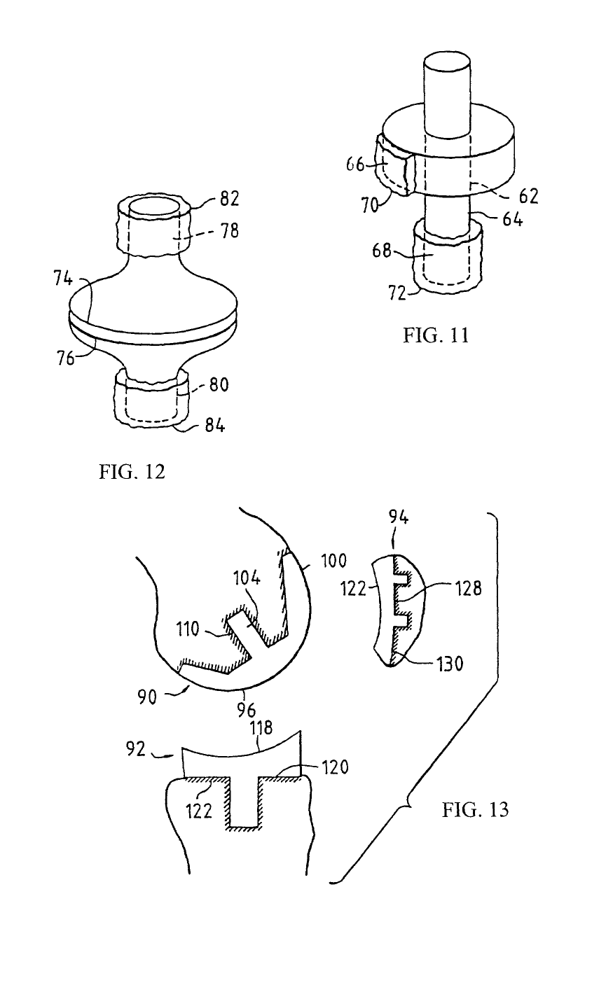

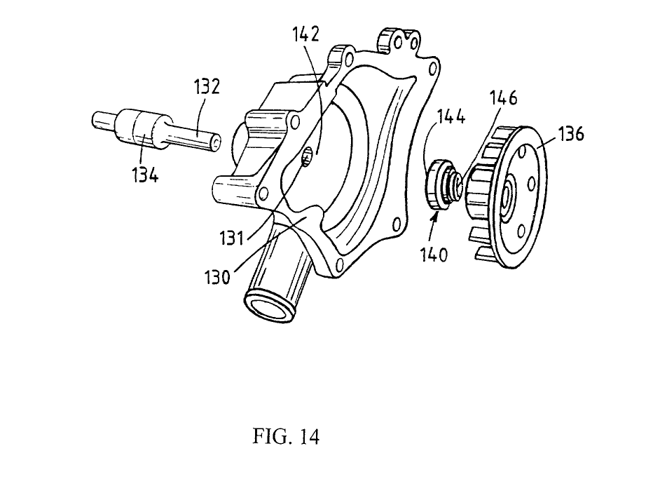

Addition of hydrogen to the gas to achieve a chlorine/hydrogen ratio of 2:0.75 to 2:1 resulted in changes in the appearance and structure of carbon coatings. The layers produced at high hydrogen contents were gray in color, translucent in thin sections, and fracture surfaces showed a continuous fracture pattern from the coating into SiC (FIG. 4a), suggesting that mechanical properties of these coatings are close to that of SiC. These coatings were grown to 50 μm in thickness (FIG. 1). CDC coatings produced with a hydrogen to chlorine molar ratio of about 1:2 had hardness in excess of 50 GPa and a Young's modulus of ˜600-800 GPa (FIG. 1). These values exceed that of diamond-like carbon (DLC) and are slightly higher than that of the SiC substrate, but below that of single crystal or CVD diamond, when measured using the same instrument (FIG. 1b). TEM shows that these coatings were built of diamond nanocrystals with the average size of 5-10 nm (FIG. 4b). In SAD pattern from this film, sharp Bragg reflections are visible up to the order of (800), indicating good crystallinity. No scattering intensity from either graphite or amorphous carbon can be seen, suggesting that the film is pure diamond. Kinematically forbidden diamond reflections (200), (222) and (420) were consistently observed during this study (Table 1, FIG. 3a, inset). Those are very common for Si and diamond crystals and may appear because the allowed (111) beam acts like a new incident beam and is rediffracted by the (111) plane exciting a weak (200) reflection. The above-mentioned reflections can also be caused by incorporation of impurity (Si) atoms in diamond and formation of an ordered superstructure. In this case, the symmetry is lowered from Fd3m to F43m (the same as in β-SiC). This would explain a high intensity of the forbidden reflections observed.

An increase in the hydrogen content to a 1:1 molar ratio, leading to the formation of HCl, resulted in very thin films or no coating at all. This may be due to a lower thermodynamic probability of reaction (2)

SiC+4HCl=SiCl₄+C+2H₂ (2)

compared to reaction (1).

In Ar-Cl₂ and Ar-Cl₂/H₂ environments, the carbon layer thickness increases linearly with time following the equation d=k₁t, where d is the layer thickness, t is time, and k, is the linear rate constant. For the Ar-2.77 mole % Cl₂—1.04 mole % H₂ environment, K₁-1.6 μm/h, which is only about 20% lower than for Ar-3.5% Cl₂. Because the kinetics is linear, the controlling factor of the reaction is not the diffusion of reactant species through the growing carbon layer. If this were the case, one would expect a parabolic rate equation. In order for the chlorination reaction to proceed, two molecules of Cl₂(g) or four molecules of HCl(g) must be transported to the SiC/C interface and one molecule of SiCl₄(g), as well as two molecules of hydrogen, must be transported away from the interface for each atom of carbon produced. Linear kinetics implies that the carbon film is nanoporous and allows for easy permeation of Cl₂, HCl, H₂ and SiCl₄ molecules, in spite of its dense appearance in SEM (FIG. 4a) at magnifications up to ×500,000. This nanoporosity is responsible for the hardness values being lower than that of CVD diamond (FIG. 1b). An important implication of the linear layer growth kinetics is the possibility of growing very thick diamond coatings on SiC or complete conversion of SiC powders or components into diamond.

Recent studies have shown that it is not difficult to form nanometer-size diamonds using high energy processing. Moreover, several groups reported nucleation of sp³-bonded carbon and nanocrystalline diamond after surface treatment of SiC by fluorocarbon plasma and bombardment with hydrogen or carbon ions. Thus, there is evidence of conversion of carbides into diamond, later removal of metal atoms from the carbide lattice under various experimental conditions. The growth of diamond from SiC in pure chlorine with no hydrogen added (FIGS. 2 and 3) is in agreement with the latest diamond synthesis showing that hydrogen is not essential for diamond growth outside its range of thermodynamic stability. However, without H₂ gas, the formed diamond surface deteriorates rapidly to amorphous carbon, so that without H₂, the reaction, at 800-1,000° C., could not be used to produce diamond coatings with thicknesses of more than a few micrometers. According to the original concept for metastable growth of diamond, it is necessary to conserve the orientational effect of the surface carbon atoms and to use carbon-containing molecules with sp³ bonding that can be attached to the diamond surface in a complementary manner. Both conditions can be satisfied when Si is extracted from SiC, forming carbon atoms in the sp³ configuration. The very first diamond growth experiments of Derjagin and Spitsyn were conducted in the carbon-halogen system using CBr₄ and CI₄. It can be assumed that the tetrahedrally coordinated SiC lattice, which is preserved during the chlorination, acts as a template of growth of diamond and that diamond grows by direct transformation of the SiC lattice because of sp3 bonding of carbon in SiC and a similar structure of β-SiC, which has a diamond lattice where 50% of carbon atoms are replaced with Si. However, the work done using α-SiC showed that any SiC polytype can be converted to diamond. Our molecular dynamics simulation using empirical interatomic Tersoff potentials shows that for a Si-terminated (1,000) 6H-SiC surface, very high lattice strains do not allow direct growth of diamond on SiC, and fragmentation, leading to nanocrystalline material, must occur. Diamond clusters on SiC demonstrate a good adhesion to the substrate and maintain sp³ coordination of carbon atoms in the cluster. TEM study of the chlorine-treated SiC suggested that SiC was converted to amorphous sp³ carbon and formation of diamond occurred within nanometers from the SiC/carbon interface. Random orientation of diamond nanocrystals (FIG. 2) in CDC supports non-epitaxial growth of diamond. Thus, growth of nanocrystalline diamond occurred from highly disordered sp³ carbon produced by selective etching of SiC. Growth of larger diamond crystals (FIG. 3a) was the result of coalescence of continuous nanocrystalline regions (FIG. 2a). However, if no hydrogen was added to the gas, under ambient pressure, nanocrystalline diamond was slowly transformed to the thermodynamically stable graphitic carbon during the long-term treatment at 1,000° C., and only amorphous and graphitic carbon resulted at a distance of more than 3 μm from the SiC/carbon interface. Thus, the role of hydrogen is primarily in stabilization of dangling bonds of carbon. This helps to maintain sp³ hybridization of carbon and prevent formation of sp² bonded carbon. Therefore, addition of hydrogen in an amount of at least 0.3 mole of hydrogen, preferably at least 0.75 mole of hydrogen, for every two moles of halogen stabilizes the diamond phase and allowed the continuous growth of a diamond film on the surface, without the diamond being converted to amorphous carbon.

The manufacturing of CDC has been well developed and scaled up during the past few years, and a variety of useful products, ranging from nanoporous carbon for supercapacitors and batteries to nanotubes, onion-like carbon and tribological coatings have been reported. The process of the present invention is versatile because it allows synthesis of diamond powders or coatings of virtually any thickness. Since the transformation is conformal and does not change the shape of the particle, powders with any grain size can be produced by using raw SiC powders of different particle sizes. However, the product will be diamond grains built of nanocrystals. Presence of micrometer-size crystals in the samples (FIG. 3a) shows that coalescence of diamond nanocrystals may occur under appropriate conditions and lead to microcrystalline diamond growth.

The mechanical, electrical and optical properties of nanocrystalline diamond are altered, because the grain boundary carbon is π-bonded, as shown by the Raman spectra and EELS. The fraction of atoms residing at grain boundaries can be up to 10% when the average crystallite size becomes 3-5 nm. Nanocrystalline diamond films have particular applications in tribology, e.g., to coat SiC dynamic seals for water pumps. Graphitic carbon in composite diamond/graphite films can act as a solid lubricant. Remarkable electron emission with turn-on fields of ˜1 V/μm and a high current density has been achieved using thin films of nanocrystalline diamond. Nanocrystalline diamond has a higher conductivity than boron-doped microcrystalline diamond and can be used for electrodes in chemically aggressive environments. Conformal coatings produced by the selective etching are useful in micro-electro-mechanical systems (MEMS) applications where very thin and uniform coatings are required. In addition, permeability of the films produced by chlorination of SiC and an extremely narrow pore size distribution in CDC provide effective molecular sieves, high-surface area electrodes and other applications, where vapor-deposited diamond films cannot be applied. The large-scale solid-state synthesis of technical diamond at ambient pressure and moderate temperatures with no plasma activation provides diamond materials at low cost for a variety of high-volume applications such as brake pads, where diamond could not be used before because of its cost.

Synthesis

Experiments were performed using several commercially available β-SiC powders, sintered α-SiC and CVD β-SiC materials; however, the examples described herein are limited to sintered α-SiC. These samples were sectioned into disks 16 mm in diameter and 1 mm thick. The disks were cleaned ultrasonically, rinsed in acetone, and placed in a quartz sample holder. This was in turn suspended via a silica wire connected to a fused silica rod in the center of a fused silica reaction tube in the hot zone of a furnace. Experiments were continued from between 30 minutes and 30 hours in a broad temperature range of (600-1,110° C.). The results presented here were obtained in experiments conducted at 1,000° C. At the end of each experimental run, the furnace and reaction gas mixture was secured and an argon purge was initiated through the reaction chamber during the cool down period.

Analysis

The reaction specimens were analyzed using optical microscopy and SEM, energy-dispersive spectroscopy (EDS), EELS, XRD, and Raman spectroscopy (Ar ion laser, 514.5 nm excitation wavelength). JEOL JEM-3010 (300 kV) and JEOL JEM-2010F (200 kV) TEMs, and JEOL 6320 field emission SEM were used for this work. EDS was used to identify the carbon areas, which were free from impurities and showed only traces of silicon and chlorine. Subsequently, SAD was performed on about 50-nm in size nanocrystalline areas and microcrystals, and CBED was performed on 5-nm and 10-nm nanocrystals. A Nano Indenter XP (MTS) equipped with a Berkovich indenter (diamond pyramid) was used to measure the hardness and Young's modulus of the coating.

What is claimed is:

1. A process for the synthesis of a diamond surface on a monolithic piece, said piece being predominantly metal carbide, by etching away at least a portion of the metal from the metal carbide, leaving essentially only carbon on at least the surface of the monolithic piece of metal carbide comprising:
reacting a surface of said monolithic piece of metal carbide with a hydrogen- and halogen-containing gaseous etchant, having a hydrogen gas concentration of at least 0 to two moles of hydrogen for every two moles of halogen, and having a halogen gas concentration sufficient to remove a portion of the metal from the metal carbide surface, at a temperature, pressure and for a time sufficient to provide essentially only diamond or diamond and carbon on the surface of said metal carbide.

2. The process of claim 1, wherein the reaction pressure is about 1 atmosphere.

3. The process of claim 1, wherein the reaction temperature is in the range of at least about 100° C.

4. The process of claim 3, wherein the reaction temperature is at least about 500° C.

5. The process of claim 4, wherein the reaction temperature is in the range of about 500° C. to about 1,100° C.

6. The process of claim 5, wherein the reaction temperature is in the range of about 800° C. to about 1,000° C. and the reaction time is in the range of about 10 minutes to about 62 hours.

7. The process of claim 6, wherein the reaction time is in the range of about 0.5 hour to about 8 hours.

8. The process of claim 1, wherein the metal carbide is silicon carbide.

9. The process of claim 1, wherein the reaction pressure is in the range of about 0 atmosphere to about two atmospheres.

10. The process of claim 1, wherein the reaction pressure is in the range of about 0 atmosphere to about one atmosphere.

11. A process for controlling the degree and type of carbon surface formed on a metal carbide comprising:
contacting a surface of a metal carbide with an etchant gas comprising a mixture of a hydrogen gas and halogen-containing gas in a molar ratio of hydrogen gas to halogen-containing gas in the range of 0:2 to 1:2; and
adjusting the concentration of halogen-containing gas, hydrogen gas, temperature and time of reaction to provide a diamond surface on said metal carbide, and mixtures of diamond and graphitic carbon thereof.

12. The process of claim 11 including contacting the metal with a first gaseous etchant having a first concentration of halogen-containing gas and first concentration of H₂, and thereafter contacting the metal carbide with a second gaseous etchant having a different concentration of both halogen-containing gas and H₂.

13. The process of claim 11, wherein the halogen-containing gas is selected from the group consisting of fluorine, chlorine, bromine, iodine, hydrogen chloride, and mixtures thereof.

14. The process of claim 13, wherein the halogen-containing gas is chlorine in a concentration of about 0.1% to about 10% by volume of the gaseous etchant.

15. An improved method of manufacturing a bearing from a mass of powdered metal carbide particles treated to include a surface layer comprising diamond for more uniform, homogeneous distribution of diamond throughout at least a portion of said metal carbide, comprising
reacting a surface of a plurality of powdered metal carbide particles with a halogen-containing and hydrogen-containing gaseous etchant, having a hydrogen gas concentration of at least 0.3 mole of hydrogen for every two moles of halogen, and having a halogen gas concentration sufficient to remove metal from the metal carbide surface, at a temperature, pressure and for a time sufficient to provide a defined percentage of diamond on the surface of said metal carbide; and
disposing said treated, powdered metal carbide particles, having a diamond surface, in a mold in a desired shape of said bearing, and heating said powdered particles at a temperature and for a time sufficient to form a coherent mass of said powdered particles in the shape of said mold, said bearing having a diamond-containing bearing surface.

16. A bearing disposed as part of a mechanical device, said mechanical device including a solid part in frictional contact with said bearing such that there is relative movement between said solid part and said bearing when the mechanical device is being operated, wherein the bearing includes a bearing surface in relative movement with respect to said solid part, said bearing surface having enhanced wear and friction properties by contacting a metal carbide, at a portion of said metal carbide that forms said bearing surface, with a halogen-containing and hydrogen-containing gaseous etchant, having a hydrogen gas concentration of at least 0.001 mole of hydrogen for every two moles of halogen, and having a halogen gas concentration sufficient to remove metal from the metal carbide surface, at a temperature, pressure and for a time sufficient to provide essentially only diamond or diamond and carbon on the bearing surface of said metal carbide.

17. The bearing of claim 16, wherein the bearing surface is a ball bearing surface in the shape of a sphere.

18. The bearing of claim 16, wherein the bearing surface is pointed, forming an end of a needle bearing.

19. The bearing of claim 16, wherein the bearing surface is cylindrical, forming a roller bearing.

20. The bearing of claim 16, wherein the bearing surface forms the bearing surface of a thrust bearing.

21. The bearing of claim 16, wherein the bearing surface is annular and surrounds a rotating shaft to seal a volume between said rotating shaft and said bearing surface to prevent fluid from flowing between said bearing surface and said rotating shaft when said shaft rotates.

22. The bearing of claim 21, wherein the seal is disposed in contact with a shaft of a water pump.

23. The bearing of claim 21, wherein the seal is disposed in contact with the shaft of an oil pump.

24. A method of manufacturing a prosthesis comprising:
shaping two monolithic metal carbide pieces such that said pieces are shaped complementary to each other, one shaped piece including an articulating end surface and the other shaped piece including a complementary shaped anchor end surface for contact with said articulating end surface, said articulating end surface moveable with respect to said anchor end surface; and
contacting at least one of said shaped pieces with a halogen-containing and hydrogen-containing gaseous etchant, having a hydrogen gas concentration of at least 0.3 mole of hydrogen for every two moles of halogen, and having a halogen gas concentration sufficient to remove metal from the metal carbide piece, at a temperature, pressure, and for a time sufficient to provide essentially only diamond, or diamond and carbon on a surface selected from the group consisting of the articulating end surface, the anchor end surface, and both the articulating end surface and the anchor surface.

25. A microstructure comprising a structural member having a surface formed by contacting a metal carbide portion of said structural member, at a surface of said metal carbide portion, with a halogen-containing and hydrogen-containing gaseous etchant, having a hydrogen gas concentration of at least 0.3 mole of hydrogen for every two moles of halogen, and having a halogen gas concentration sufficient to remove metal from the metal carbide surface, at a temperature, pressure and for a time sufficient to provide essentially only diamond or only diamond and carbon on the surface of said metal carbide portion.

26. The microstructure of claim 25, wherein the silicon microstructure includes an electromechanical apparatus.

27. The microstructure of claim 26, wherein the structural member is a moving member of the electromechanical apparatus.

28. The microstructure of claim 26, wherein the structural member includes an electrical contact.

29. A microelectromechanical device comprising a structural member having a surface formed by contacting a metal carbide portion of said structural member, at a surface of said metal carbide portion, with a halogen-containing and hydrogen-containing gaseous etchant, having a hydrogen gas concentration of 0 to two moles of hydrogen for every two moles of halogen, and having a halogen gas concentration sufficient to remove metal from the metal carbide surface, at a temperature, pressure and for a time sufficient to provide essentially only diamond or only diamond and carbon on the surface of said metal carbide portion.

30. The microelectromechanical device of claim 29, wherein the microelectromechanical device includes an accelerometer.

31. The microelectromechanical device of claim 29, wherein the microelectromechanical device includes an electrical switch.

32. The microelectromechanical device of claim 29, wherein the microelectromechanical device includes a valve for controlling the flow of a fluid.

33. The microelectromechanical device of claim 29, wherein the microelectromechanical device includes a fluid pump.

34. The microelectromechanical device of claim 29, wherein the microelectromechanical device includes an electric motor.

35. A catalyst comprising a catalyst support containing a metal catalyst said catalyst support comprising diamond formed by contacting a metal carbide, at a portion of said metal carbide that forms said catalyst support surface with a halogen-containing and hydrogen-containing gaseous etchant, having a hydrogen gas concentration of at least 0.3 moles of hydrogen for every two moles of halogen, and having a halogen gas concentration sufficient to remove metal from the metal carbide surface, at a temperature, pressure and for a time sufficient to provide essentially only diamond or only diamond and carbon on the catalyst support surface of said metal carbide.

36. A molecular sieve for separation of molecules comprising carbon formed by contacting a metal carbide, at a portion of said metal carbide that forms said molecular sieve surface with a halogen-containing and hydrogen-containing gaseous etchant, having a hydrogen gas concentration of at least 0.3 mole of hydrogen for every two moles of halogen, and having a halogen gas concentration sufficient to remove metal from the metal carbide surface, at a temperature, pressure and for a time sufficient to provide essentially only diamond or essentially only diamond and carbon on the molecular sieve surface of said metal carbide.

37. A process for the synthesis of an ion-exchange material from a monolithic piece of predominantly metal carbide, by etching away at least a portion of the metal from the metal carbide, leaving essentially only carbon on at least the surface of the monolithic piece of metal carbide comprising:
reacting a surface of said monolithic piece of metal carbide with a halogen-containing and hydrogen-containing gaseous etchant, having a hydrogen gas concentration of at least 0.3 mole of hydrogen for every two moles of halogen, and having a halogen gas concentration sufficient to remove a portion of the metal from the metal carbide surface, at a temperature, pressure and for a time sufficient to provide essentially only diamond or only diamond and carbon on the surface of said metal carbide; and
seeding said formed carbon surface with exchangeable ions.
